(19) United States
(12) Patent Application Publication
(10) Pub. No.: US 2023/0177395 A1
(43) Pub. Date: Jun. 8, 2023

(54) METHOD AND SYSTEM FOR AUTOMATICALLY DISPLAYING CONTENT BASED ON KEY MOMENTS

(71) Applicant: Itai ARBEL, Tel Aviv (IL)

(72) Inventor: Itai ARBEL, Tel Aviv (IL)

(21) Appl. No.: 17/994,463

(22) Filed: Nov. 28, 2022

Related U.S. Application Data
(60) Provisional application No. 63/286,049, filed on Dec. 5, 2021.

(51) Int. Cl. G06N 20/00

(52) U.S. Cl. CPC G06N 20/00

(57) ABSTRACT

A system for automatically displaying content based on key moments includes: rules and database; a key moments machine learning module connected with at least one match detector module of at least one external entity; a key signals detector module connected with at least one content owner, the rules and database; and the key moments machine learning module; and a viewer connected with the at least one match detector module. The key signals detector module is configured to receive a video from at least one of the at least one content owner, and detect at least one key signal in the video. The key moments machine learning module is configured to receive the detected at least one key signal and detect at least one key moment; and at least one of the at least one match detector module is configured to receive the detected at least one key moment and decide when to display the content to the viewer.

### FIELD OF THE INVENTION

The present invention generally relates to the field of video analysis and specifically to displaying content based on key moments detected in video.

### BACKGROUND

Advertising or presenting an interactive content to a viewer using media, such as television, radio, newspapers and magazines, is well known. Advertisers or content owners/broadcasters use these types of media to reach a large audience with their advertisements (“ads”) or interactive content. In order to reach a more responsive audience, advertisers and content owners/broadcasters use demographic studies. For example, advertisers may use broadcast events such as football games to advertise beer and action movies to a younger male audience. However, even with demographic studies and entirely reasonable assumptions about the typical audience of various media outlets, advertisers recognize that much of their ad budget is simply wasted because the target audience is not interested in the ad they are receiving or that the timing of presenting the advertisement or the interactive content is incorrect.

It would be useful, therefore, to have a method and system for providing relevant ads or interactive content at the right moment.

Therefore, there is a need for a method and system for automatically detecting key moments in a video in order to optimize the display of advertisements and/or interactive content.

### SUMMARY

According to an aspect of the present invention there is provided a system for automatically displaying content based on key moments, comprising: rules and database; a key moments machine learning module connected with at least one match detector module of at least one external entity; a key signals detector module connected with at least one content owner, the rules and database; and the key moments machine learning module; and a viewer connected with the at least one match detector module; wherein the key signals detector module is configured to receive a video from at least one of the at least one content owner, and detect at least one key signal in the video;
wherein the key moments machine learning module is configured to receive the detected at least one key signal and detect at least one key moment; and wherein at least one of the at least one match detector module is configured to receive the detected at least one key moment and decide when to display the content to the viewer.

The key signals detector module may further be configured to receive video type metadata of the video from the at last one of the at least one content owner.

The key moments machine learning module may further be configured to receive at least one of: at least one rule; and at least one previously detected key signal from the rules and database.

The at least one external entity may comprise at least one ad unit.

The detection of the at least one key signal in the video may be configured to be performed by extracting, from the video, at least one of: word, sound, volume, pitch, object, color, velocity and size of objects.

The at least one match detector module may further be configured to receive demographic information of the viewer.

The demographic information may comprise at least one of: viewer's location, viewer's age and viewer's income level.

The content may comprise at least one of: advertisement, interactive question and interactive content.

The key moments machine learning module may further be connected with the viewer; wherein the key moments machine learning module may further be configured to receive feedback from the viewer.

The at least one match detector module may further be configured to receive feedback from the viewer.

The feedback may comprise at least one of: engagement ratio, closing ratio and ignoring ratio.

The at least one key moment may comprise at least one of: fear, anger, sadness, joy, disgust, surprise, anticipation, win, celebration, success, failure, boredom, danger and relaxation.

The at least one key signal may comprise at least one of: smiles, handshake, hand wave, hug, face expressions, tears, sweat, love words, swears, admiration words, danger related words, judge whistle, fans jump, fans cheer, running, walking, sleeping, increase speed, decrease speed, jump, raise hands, goal, ball, stretcher, bed, car, house, increasing speed of a ball, long distance movement of a ball, standing still ball, yell, cry, laugh, high pitch voice, low pitch voice and crash.

According to another aspect of the present invention there is provided a method of automatically displaying content based on key moments, comprising: receiving, by a key signals detector module, a video from at least one content owner and detecting at least one key signal in the video; receiving, by a key moments machine learning module, the detected at least one key signal and detecting at least one key moment; sending, by the key moments machine learning module, the detected at least one key moment to at least one match detector module of at least one external entity; deciding, by the at least one match detector module, when to display the content to a viewer based on the detected at least one key moment.

The method may further comprise receiving, by the key signals detector module, video type metadata of the video from at last one of the at least one content owner.

The method may further comprise receiving, by the key moments machine learning module, at least one of: at least one rule; and at least one previously detected key signal from rules and database.

The at least one external entity may comprise at least one ad unit.

The detection of the at least one key signal may comprise extracting, from the video, at least one of: word, sound, volume, pitch, object, color, velocity and size of objects.

The method may further comprise receiving, by the at least one match detector module, demographic information of the viewer.

The demographic information may comprise at least one of: viewer's location, viewer's age and viewer's income level.

The content may comprise at least one of: advertisement, interactive question and interactive content.

The method may further comprise receiving, by the key moments machine learning module, feedback from the viewer.

The method may further comprise receiving, by the at least one match detector module, feedback from the viewer.

The feedback may comprise at least one of: engagement ratio, closing ratio and ignoring ratio.

The at least one key moment may comprise at least one of: fear, anger, sadness, joy, disgust, surprise, anticipation, win, celebration, success, failure, boredom, danger and relaxation.

The at least one key signal may comprise at least one of: smiles, handshake, hand wave, hug, face expressions, tears, sweat, love words, swears, admiration words, danger related words, judge whistle, fans jump, fans cheer, running, walking, sleeping, increase speed, decrease speed, jump, raise hands, goal, ball, stretcher, bed, car, house, increasing speed of a ball, long distance movement of a ball, standing still ball, yell, cry, laugh, high pitch voice, low pitch voice and crash.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows a block diagram of the system, according to embodiments of the present invention; and

FIG. 2 is a flowchart showing the process performed by the system, according to embodiments of the present invention.

### DETAILED DESCRIPTION OF PREFERRED EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the viewer's computer, partly on the viewer's computer, as a stand-alone software package, partly on the viewer's computer and partly on a remote computer or entirely on the remote computer or server. In the latter scenario, the remote computer may be connected to the viewer's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention provides a system and method for automatically displaying content based on key moments detected in video.

Examples of videos may be, but are not limited to, sports events, such as, a soccer match, a basketball match, a tennis match, etc., TV shows, series, live broadcasts and the like.

The term ‘key moment’ as used hereinbelow refers to parts in the video where something special is happening. It can be human emotions in high level, disasters, celebrations, wins, gestures and more. Examples of such key moments may be, but are not limited to, fear, anger, sadness, joy, disgust, surprise, anticipation, win, celebration, success, failure, boredom, danger, relaxation and the like.

The recognition of those moments can be valuable to advertisers and broadcasters seeking to better advertise or engage/interact with audience.

The term ‘key signal’ as used hereinbelow refers to signals which appear on the screen and represent key moments.

Examples of such key signals may be, but are not limited to:

Human visual impressions: (image)
Smiles, handshake, hand wave, hug, face expressions, tears, sweat, etc.

Human words: (sound)
Love words, swears, admiration words, danger related words, judge whistle, etc.

Crowd behavior
Fans jump, fans cheer, etc.

Actors behavior
Running, walking, sleeping, increase speed, decrease speed, jump, raise hands, etc.

Objects:
Goal, ball, stretcher, bed, car, house, etc.

Object Movement
Increasing speed of a ball, long distance movement of a ball, standing still ball, etc.

Human & object sounds:
Yell, cry, laugh, high pitch voice, low pitch voice, crash, etc.

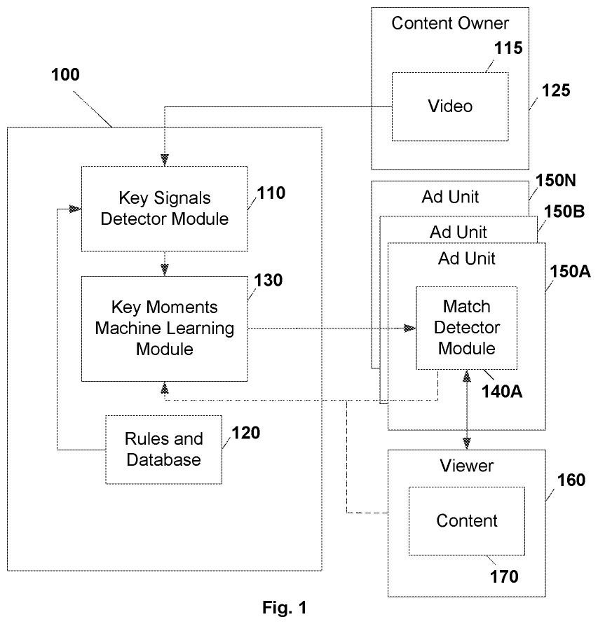

FIG. 1 shows a block diagram of the system for automatically displaying content based on key moments 100, according to embodiments of the present invention. The system 100 comprises a key signals detector module 110 connected with content owner 125 which provides video 115, and with rules and database 120. The key signals detector module 110 detects key signals in video 115 (which may be sent to the key signals detector module 110 with the video type metadata). The key signals detection may be done, for example, by extracting, from the video, words, sound, volume, pitch, objects, colors, velocity and size of objects and more; and by using the rules and database 120 which provides basic rules and previously detected or tagged key signals. The key signals detector module 110 is further connected with a key moments machine learning module 130 which receives the key signals from module 110 and detects, using machine learning capabilities, key moments. The key moments machine learning module 130 is further connected with at least one match detector module 140A-140N (only 140A is shown) of a corresponding at least one external entity such as, for example, at least one ad unit 150A-150N. The match detector module 140A is intended to receive the key moments, and optionally, the video type metadata, from the key moments machine learning module 130 and demographic information of viewer 160, and decide when to display the content 170 to the viewer 160. As mentioned above, the content may be an advertisement, an interactive question, or any other content, interactive or not, which may be needed to be presented to the viewer. The demographic information may be, for example, the viewer's location which may be determined, for example, based on IP address or external tools; the viewer's age, income level and the like which may be provided, for example, by third party providers.

According to embodiments of the present invention, feedback provided by the viewer 160 back to the key moments machine learning module 130 and/or to the match detector module 140A may improve the performance of the system over time and the accuracy level and/or the relevancy of the displayed content. Such feedback may be, but is not limited to, an engagement ratio—the number of viewers that interacted with the presented content, a closing ratio—the number of viewers that dismissed the presented content, an ignoring ratio—the number of viewers that ignored the presented content and more.

As a result, each viewer may view a personally customized content, in a specific moment in the video represented by at least one key moment, and optionally according to the viewer's demographic information.

According to embodiments of the present invention, the system 100 may further comprise an Application Program Interface (API) module configured to enable communication with the content owner 125, the at least one ad unit 150A-150N and the viewer 160.

As said above, the present invention analyzes a video and detects key moments in the video. Over time, the system learns and improves the accuracy of the key moments' detection and therefore, the accuracy of the content being displayed and the exact moment to present it.

According to embodiments of the present invention, as an initial state, by manually tagging key signals with key moments and saving those tagged key moments in the rules and database 120, the system may be trained to detect key moments.

The key signals detector module 110, may use, but is not limited to use the following technologies:
1. Project DeepSpeech provided by Mozilla.
2. Tensorflow provided by Google.
3. Open CV provided by Intel.
4. Any other known in the art service for analyzing a video.

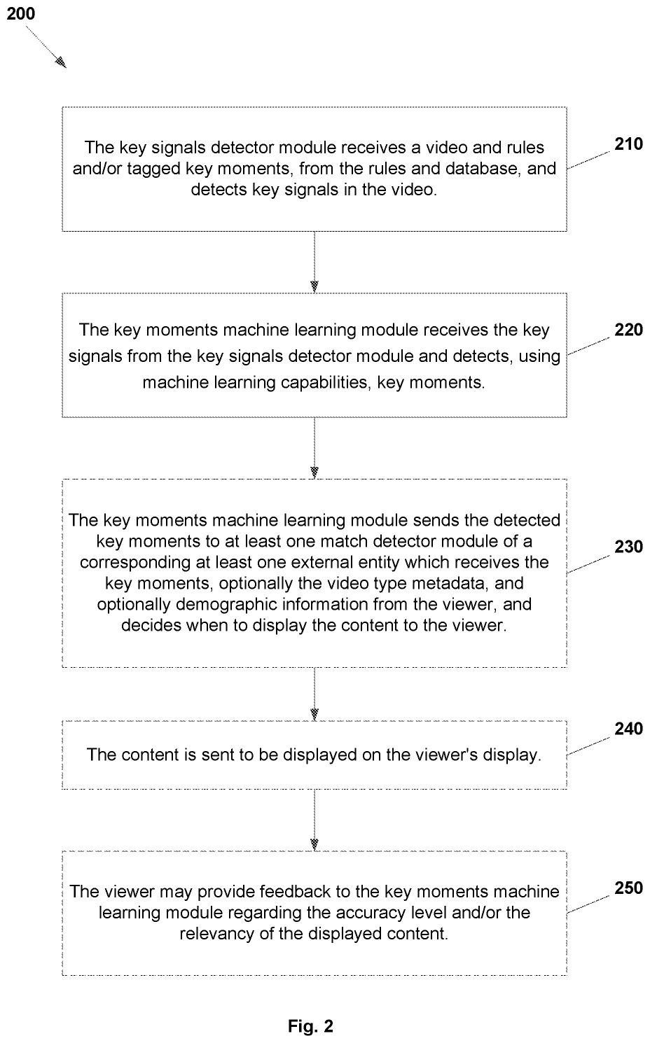

FIG. 2 is a flowchart 200 showing the process performed by the system 100, according to embodiments of the present invention.

In step 210, the key signals detector module 110 receives a video 115 and rules and/or tagged key moments, from the rules and database 120, and detects key signals in the video 115.

In step 220, the key moments machine learning module 130 receives the key signals from the key signals detector module 110 and detects, using machine learning capabilities, key moments.

In step 230, the key moments machine learning module 130 sends the detected key moments to at least one match detector module 140A of a corresponding at least one external entity 150A which receives the key moments, optionally the video type metadata, and optionally demographic information from the viewer, and decides when to display the content 170 to the viewer 160.

In step 240, the content 170 is sent to be displayed on the viewer's display.

In step 250, the viewer 160 may provide feedback to the key moments machine learning module 130 regarding the accuracy level and/or the relevancy of the displayed content.

It will be appreciated that the process may end in step 220 by detecting the key moments.

It will also be appreciated that the process may end in step 240 by displaying the content to 170 the viewer 160.

It will also be appreciated that, according to embodiments of the present invention, the process described above is performed in real time.

An exemplary scenario may be, a viewer watching a soccer match between Real Madrid and FC Barcelona.

The viewer is 24 years old living in Barcelona.

The advertiser is Nike,

The Ad Unit has the following definitions:
Present content whenever Messi scores a goal
Ad unit creative: “Buy Messrs shoes—Nike”
Add a button with a link to the nearest Nike shop.
Present the content to viewers in the ages of 18-42, which live in Spain.

In minute 24:00 Messi scores a goal and the content is presented to the viewer.

Another exemplary scenario may be, a viewer watching a soccer match between Real Madrid and FC Barcelona.

The viewer is 24 years old living in Barcelona

The advertiser is Nike.

The Ad Unit has the following definitions:
Present content whenever a “Celebration” key moment is detected.
Ad unit creative: “Wear Messi's shoes and win—Nike”
Add a button with a link to the nearest Nike shop
Present the content to viewers in the ages of 18-42, which live in Spain

In min 24:00 Messi scores.

The machine learning module 130 recognizes key signals appearing on the screen which represent “Celebration” key moment(s).

The content is presented to the viewer.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. A system for automatically displaying content based on key moments, comprising:
rules and database;
a key moments machine learning module connected with at least one match detector module of at least one external entity;
a key signals detector module connected with at least one content owner, said rules and database; and said key moments machine learning module; and
a viewer connected with said at least one match detector module;
wherein said key signals detector module is configured to receive a video from at least one of said at least one content owner, and detect at least one key signal in said video;
wherein said key moments machine learning module is configured to receive said detected at least one key signal and detect at least one key moment; and
wherein at least one of said at least one match detector module is configured to receive said detected at least one key moment and decide when to display said content to said viewer.

2. The system of claim 1, wherein said key signals detector module is further configured to receive video type metadata of said video from said at last one of said at least one content owner.

3. The system of claim 1, wherein said key moments machine learning module is further configured to receive at least one of: at least one rule; and at least one previously detected key signal from said rules and database.

4. The system of claim 1, wherein said at least one external entity comprises at least one ad unit.

5. The system of claim 1, wherein said detection of at least one key signal in said video is configured to be performed by extracting, from said video, at least one of: word, sound, volume, pitch, object, color, velocity and size of objects.

6. The system of claim 1, wherein said at least one match detector module is further configured to receive demographic information of said viewer.

7. The system of claim 6, wherein said demographic information comprises at least one of: viewer's location, viewer's age and viewer's income level.

8. The system of claim 1, wherein said content comprises at least one of:
advertisement, interactive question and interactive content.

9. The system of claim 1, wherein said key moments machine learning module is further connected with said viewer; wherein said key moments machine learning module is further configured to receive feedback from said viewer.

10. The system of claim 1, wherein said at least one match detector module is further configured to receive feedback from said viewer.

11. The system of claim 9, wherein said feedback comprises at least one of:
engagement ratio, closing ratio and ignoring ratio.

12. The system of claim 1, wherein said at least one key moment comprises at least one of: fear, anger, sadness, joy, disgust, surprise, anticipation, win, celebration, success, failure, boredom, danger and relaxation.

13. The system of claim 1, wherein said at least one key signal comprises at least one of: smiles, handshake, hand wave, hug, face expressions, tears, sweat, love words, swears, admiration words, danger related words, judge whistle, fans jump, fans cheer, running, walking, sleeping, increase speed, decrease speed, jump, raise hands, goal, ball, stretcher, bed, car, house, increasing speed of a ball, long distance movement of a ball, standing still ball, yell, cry, laugh, high pitch voice, low pitch voice and crash.

14. A method of automatically displaying content based on key moments, comprising:
receiving, by a key signals detector module, a video from at least one content owner and detecting at least one key signal in said video;
receiving, by a key moments machine learning module, said detected at least one key signal and detecting at least one key moment;
sending, by said key moments machine learning module, said detected at least one key moment to at least one match detector module of at least one external entity;
deciding, by said at least one match detector module, when to display said content to a viewer based on said detected at least one key moment.

15. The method of claim 14, further comprising receiving, by said key signals detector module, video type metadata of said video from at last one of said at least one content owner.

16. The method of claim 14, further comprising receiving, by said key moments machine learning module, at least one of: at least one rule; and at least one previously detected key signal from rules and database.

17. The method of claim 14, wherein said at least one external entity comprises at least one ad unit.

18. The method of claim 14, wherein said detecting at least one key signal comprises extracting, from said video, at least one of: word, sound, volume, pitch, object, color, velocity and size of objects.

19. The method of claim 14, further comprising receiving, by said at least one match detector module, demographic information of said viewer.

20. The method of claim 19, wherein said demographic information comprises at least one of: viewer's location, viewer's age and viewer's income level.

21. The method of claim 14, wherein said content comprises at least one of:
advertisement, interactive question and interactive content.

22. The method of claim 14, further comprising receiving, by said key moments machine learning module, feedback from said viewer.

23. The method of claim 14, further comprising receiving, by said at least one match detector module, feedback from said viewer.

24. The method of claim 23, wherein said feedback comprises at least one of:
engagement ratio, closing ratio and ignoring ratio.

25. The method of claim 14, wherein said at least one key moment comprises at least one of: fear, anger, sadness, joy, disgust, surprise, anticipation, win, celebration, success, failure, boredom, danger and relaxation.

26. The method of claim 14, wherein said at least one key signal comprises at least one of: smiles, handshake, hand wave, hug, face expressions, tears, sweat, love words, swears, admiration words, danger related words, judge whistle, fans jump, fans cheer, running, walking, sleeping, increase speed, decrease speed, jump, raise hands, goal, ball, stretcher, bed, car, house, increasing speed of a ball, long distance movement of a ball, standing still ball, yell, cry, laugh, high pitch voice, low pitch voice and crash.
